(19) United States
(12) Patent Application Publication
(10) Pub. No.: US 2025/0348576 A1
(43) Pub. Date: Nov. 13, 2025

(54) SYSTEMS AND METHODS FOR PROCESS AND FILE BEHAVIORAL EXECUTION PREVENTION

(71) Applicant: Cybereason Inc., Boston, MA (US)

(72) Inventors: Boris Mechetner, Kiryat Ono (IL); Michal Ratner, Jerusalem (IL)

(73) Assignee: Cybereason Inc., Boston, MA (US)

(21) Appl. No.: 19/202,140

(22) Filed: May 8, 2025

Related U.S. Application Data
(60) Provisional application No. 63/644,214, filed on May 8, 2024.

(51) Int. Cl. G06F 21/53

(52) U.S. Cl. CPC G06F 21/53; G06F 2221/033

(57) ABSTRACT

Disclosed is a method for process and file behavioral execution prevention. The method can include executing a sandboxed program within a kernel of a computing device; detecting, via the sandboxed program, an event or a condition; in response to detecting the event or condition, invoking a callback function executing custom logic; invoking, via a tailing mechanism, a second sandboxed program to execute within the kernel; and writing outputs of the first and second sandboxed programs to a shared map.

### CROSS REFERENCE TO RELATED APPLICATIONS

This application claims priority to U.S. Provisional Application No. 63/644,214, filed May 8, 2024, which is herein incorporated by reference in its entirety.

### BACKGROUND OF THE DISCLOSURE

In various operating systems, hooking independently to the kernel is generally deprecated. While kext (a kernel extension can be used to implement hooking logic and alter executions depending on the decision-making of a rules engine, this is not generally desirable and has various shortcomings. Today, it is often recommended to use the Apple Endpoint Security library, a component that functions as a kernel-based solution to security needs and is capable of providing proactive detection and response for real-time events. When this functionality is employed, a new client is created that holds a callback to the OS. The client can be added with special events (i.e., authorization events). The authorization events callback creates a decision point in user-space to which a user can decline or permit the execution.

Another method is to implement a desired hook logic to create a driver that sets a callback routine. For example, by calling a PsSetCreateProcessNotifyRoutine function, the operating system would call the routine anytime a process is created or deleted.

However, these methods come with various shortcomings, such as the limitations that kernel security rules place on these techniques. Therefore, the complexity of logic capable of being implemented within the kernel is unnecessarily limited.

### SUMMARY OF THE DISCLOSURE

According to one aspect of the present disclosure, a method for process and file behavioral execution prevention can include executing a first sandboxed program within a kernel of a computing device; detecting, via the sandboxed program, an event or a condition; in response to detecting the event or condition, invoking a callback function executing custom logic; invoking, via a tailing mechanism, a second sandboxed program to execute within the kernel; and writing outputs of the first and second sandboxed programs to a shared map.

In some embodiments, the first and second sandboxed programs can be extended Berkeley Packet Filter (eBpf) programs. In some embodiments, the shared map can include an eBpf shared map. In some embodiments, the first and second sandboxed programs can be attached between the kernel and respective callback functions. In some embodiments, the method can include, in response to the second sandboxed program completing execution, performing an override return. In some embodiments, the event or the condition can include at least one of opening a file or initiating a process. In some embodiments, executing the custom logic can include at least one of inspecting or modifying a data structure or invoking an additional kernel function. In some embodiments, the custom logic can be executed to prevent malicious activity.

According to another aspect of the present disclosure, a computing system can include a processor and a non-transitory computer-readable storage device storing computer-executable instructions, the instructions when executed by the processor cause the processor to perform operations. The operations can include executing a first sandboxed program within a kernel of a computing device; detecting, via the sandboxed program, an event or a condition; in response to detecting the event or condition, invoking a callback function executing custom logic; invoking, via a tailing mechanism, a second sandboxed program to execute within the kernel; and writing outputs of the first and second sandboxed programs to a shared map.

In some embodiments, the first and second sandboxed programs can be extended Berkeley Packet Filter (eBpf) programs. In some embodiments, the shared map can include an eBpf shared map. In some embodiments, the first and second sandboxed programs can be attached between the kernel and respective callback functions. In some embodiments, the operations can include, in response to the second sandboxed program completing execution, performing an override return. In some embodiments, the event or the condition can include at least one of opening a file or initiating a process. In some embodiments, executing the custom logic can include at least one of inspecting or modifying a data structure or invoking an additional kernel function. In some embodiments, the custom logic can be executed to prevent malicious activity.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is a block diagram of an example system for process and file behavioral execution prevention according to example embodiments of the present disclosure.

FIG. 2 is an example flow pattern for process and file behavioral execution prevention according to some embodiments of the present disclosure.

FIG. 3 shows an example process for configuring a method for process and file behavioral execution prevention according to some embodiments of the present disclosure.

FIG. 4 shows an example process for process and file behavioral execution prevention according to some embodiments of the present disclosure.

FIG. 5 is an example server device according to an embodiment of the present disclosure.

FIG. 6 is an example computing device according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the invention or the applications of its use.

To the extent possible, performing execution of processes in the kernel space (rather than the user space) of a computing device can be preferable because it is significantly faster and more powerful. However, as discussed above, it can be more difficult because of the limitations, permissions, etc. that are dealt with in the kernel space. Moreover, there can be additional risks that come from operating within the kernel. As the kernel code is closer to the resources, it can consume a lot of computational power relative to others, which can leave other parts of the system broken or negatively impacted in other ways.

eBpf (Berkeley Packet Filter) is a technology that can run sandboxed programs in a privileged context such as the kernel of an operating system. It can be used to safely and efficiently extend the capabilities at the kernel level at runtime without requiring to change kernel source code or load kernel modules. One option for using eBpf can be based on the BPF Compiler Collection (BCC) framework, a toolkit for creating efficient kernel tracing and manipulation programs using eBpf. BCC can make eBpf programs easier to write with kernel instrumentation in C.

eBpf uses an entity called Ebpf program, which enables the hooking of a kernel function. For example, a Linux® hook is a mechanism that allows external code to intercept and modify the behavior of the kernel at runtime. Kernel hooks generally involve the following: 1) hook registration; 2) hook invocation; 3) callback function execution; and 4) control flow.

A hook generally will be registered within the kernel, which can involve providing a callback function that will be executed when a specific event or condition occurs. A callback function is a function that is passed as an argument to another function to be “called back” at a later time when it is getting executed. Hook invocation refers to the fact that, when the event or condition occurs, the kernel invokes the registered callback function. The hook's callback function is executed in the context of the kernel, allowing it to access and modify kernel data structures and perform privileged operations with the privilege of the kernel.

Within the callback function, developers can implement custom logic to extend or modify the kernel's behavior. This can involve inspecting and modifying data structures, invoking additional kernel functions, or performing other operations necessary to achieve the desired functionality. Finally, after executing the callback function, control is returned to the kernel, which resumes its normal execution flow. The modifications made by the hook can influence subsequence kernel behavior or alter results of certain operations.

eBpf hook registration can be made by loading an eBpf program and attacking a hook between an execution of a kernel function and the registered callback function which would be located in the eBpf program.

In addition, eBpf uses the BPF kernel verifier, which is a component of the Linux® kernel that performs static analysis and validation of eBpf programs to ensure their safety, correctness, and adherence to security policies before they are executed. The verifier can run when trying to load an eBpf program. If the verification fails, the program will be rejected and won't be loaded. Verification can fail due to many violations such as, but not limited to, out-of-bounds memory access; an invalid function call where only a valid eBpf helper function or an allowed function call within the context of the eBpf program can be called; an infinite or unbound loop, where the eBpf verifier performs control flow analysis and detects unsafe loops to prevent potential denial of service scenarios (which can be implemented by limiting the size of the recursion stack); unsupported instruction, where, if the eBpf verifier encounters an instruction that is not supported or allowed within the eBpf instruction set architecture (e.g., as directly invoking a system call using assembly code), the program can be rejected; insufficient stack space, where the verifier checks the memory access bounds and determines if the accessed memory exceeds the available stack space and, as a result, the program can be rejected; and exceeding maximum instructions, where the eBpf verifier has a limit on the maximum number of instructions allowed for a program.

Therefore, the compute power of eBpf is, by default, limited by the verifier. However, the disclosed systems and methods can utilize the eBpf tailing mechanism to overcome this. eBpf can enable the extension of hooks by allowing one eBpf program to invoke another eBpf program. When an eBpf program encounters a tail call instruction, it transfer control to another eBpf program specified by its program ID, reuses the current process stack, and jumps into another eBpf program without adding an extra stack frame. The process stack contains the temporary data such as method/function parameters, return address, and local variables. Moreover, it dynamically allocates memory to a process during its runtime, and the set of data on the stack is called a frame. This transfer of control can happen without returning control to the original program (hence the term “tail call”). The called program can execute its own logic with the ability to call itself recursively, and it may also perform a tail call to yet another eBpf program, creating a chain of program invocations. This functionality is generally used to extend the compute power of a single eBpf program. eBpf tailing can also involve the following limits: 1) each iteration can be limited by its complexity and instruction length; and 2) the tailing recursive depth can be limited to 33 iterations.

Therefore, in addition, to implement real-time prevention capabilities in the disclosed process and file behavioral execution prevention techniques, the eBpf override return functionality (bpf_override_returnfunction) can also be used. The eBpf override return function can allow a program, when attached to the entry of a kernel function, to skip the execution of the function and immediately return a specified value instead. This capability is commonly utilized for targeted error injection purposes, but has a limitation in that it can only be used in hooks to functions which are compiled in the kernel with the flag ALLOW_ERROR_INJECTION (these are mostly system calls in practice). This limitation can create problems when both override returns and tail calls are desired.

Therefore, in order to compute complex rule and prevention decision logic, the disclosed embodiments can use tail calls and, after executing extensive logic in these tail calls, remain within the original kernel function entry and allow for the use of an override return.

Embodiments of the present disclosure therefore relate to systems and methods for process and file behavioral execution prevention that run extended logic under a kernel function. The disclosed systems and methods can overcome the limitations built into the kernel by bypassing the many security rules that are typically processed at the kernel level and deciding whether to perform a certain action (e.g., prevent an execution of a process or access a file). This can also be performed in real-time. The disclosed systems and methods can use eBpf tails and multiple hooks.

As discussed above, a kernel hook (e.g., a Linux® kernel hook) is a mechanism that allows developers to intercept and modify specific operations or events within the kernel by providing customizable entry points for executing custom code. In some embodiments, hooking can be performed multiple times on the same kernel function and with a predefined deterministic order. Such a deterministic order, which is achieved using a built-in kernel hooking mechanism, can be used by eBpf as part of its application programming interface (API), such as by attaching a kprobe with the BCC attach_kprobe( ) function.

In some embodiments, the attach_kprobe( ) function can encompass two methodologies for using the kprobe interface, depending on the kernel version. In kernels starting from 4.17, the attach_kprobe( ) function can use the perf_event_open( ) system call on the perf event mechanism, where a performance monitoring unit (PMU) called perf_kprobe creates a kprobe that is private to the perf_event and attaches it to the file descriptor generated by perf_event_open. As part of the initialization of the perf mechanism in the kernel, the perf_kprobe feature is built.

In older kernels, kprobes can be created with BCC via a text-based API (e.g., kprove_events in tracefs) by writing configuration strings to certain files. As part of the initialization of the tracefs mechanism, the kprobe events ops feature is built and, later, kprobes are dynamically registered when they are appended to the file.

In both of these methods, a register trace kprove function can be triggered that calls a kprobe optimization function (e.g., try_to_optimize_kprobe). The optimization function can call to a function, such as init_aggr_kprobe, which creates an aggregator kprove, which is held in a list with a predefined order, and replaces the original kprobe with an aggregator kprobe. Then, the pre_handler is redefined as the aggr_pre_handler, which can iterate over the registered kprobes and call their pre_handlers, providing a multi-hooking mechanism.

Individual hooks can, in their default state, lack awareness of other hooks. Therefore, to enable multiple hooks to engage and exchange data and thus create a coherent and logical flow between them, the disclosed embodiments can utilize eBpf maps, which are a method for keeping state between invocations of the eBpf program. In addition, eBpf maps enable the sharing of data between eBpf kernel programs and between kernel and user-space applications. Using such maps between multiple hooks therefore can allow the disclosed systems to maintain the rule matching state of the rules engine. Once the rules match the metadata, the disclosed system can prevent execution of the process creation or file access. Such prevention can be done using an override return from within the last hook in the multiple hooks system.

The disclosed systems and embodiments therefore combine numerous features of eBpf in a single flow that enables the introduction of significant logical complexity within the kernel space. Such logic can then be used to prevent system calls using override return, which can ultimately be used to, for example, protect a computer system from a malicious program.

In addition, the disclosed systems and methods can be extended to a general purpose library, extending the compute power of any hook callback function that is naturally restricted by the eBpf verifier. It can utilize the multiple-hooks mechanism along with tailing functionality, which is limited in its recursion depth, and an eBpf map to correlate between the multiple hooks, as explained above.

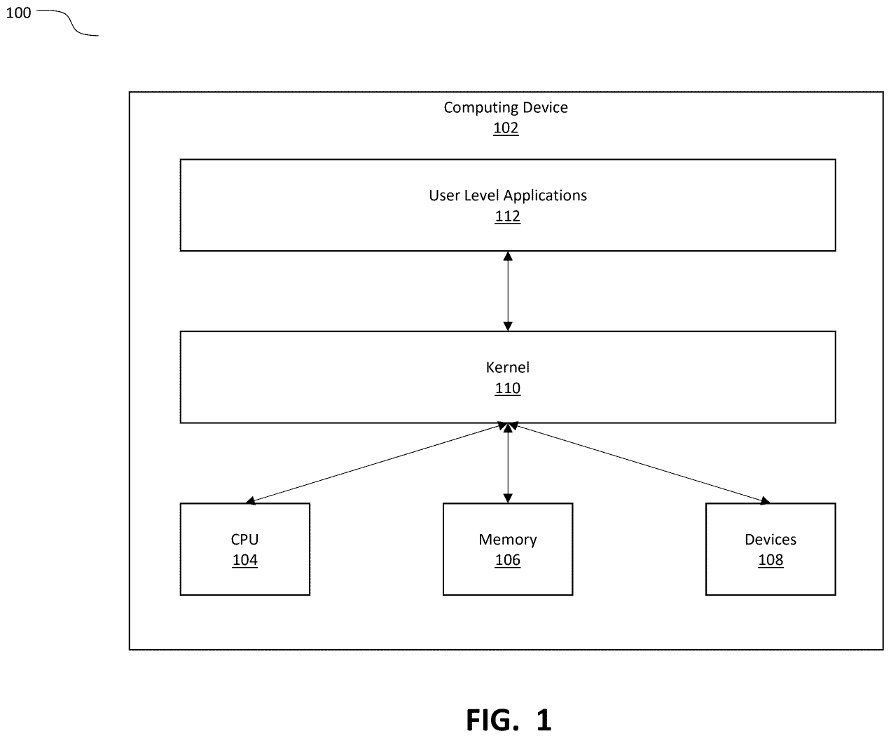

FIG. 1 is a block diagram of an example system 100 for process and file behavioral execution prevention according to example embodiments of the present disclosure. The system 100 illustrates the makeup of a computing device 102. The computing device 102 utilizes user level applications 112 and a kernel 110. The user level applications 112 refer to a “user space” that runs various programs and libraries that can interact with the kernel 110. For example, user level applications 112 can utilize inputs and outputs (e.g., from a user), manipulate objects in a file system, and execute other user applications. In addition, an operating system (OS) would be within the space of the user level applications 112. In addition, the kernel 110 can refer to the core of the computing device 102 that provides various underlying services, such as process and memory management, file systems, device control, networking, etc. For example, the kernel 110 can interact the CPU 104, memory 106, and networking devices 108. As discussed above, performing the execution of processes in the space of the kernel 110, the “kernel space” (rather than the user space of the user level applications 112) of a computing device can be preferable because it is significantly faster and more powerful.

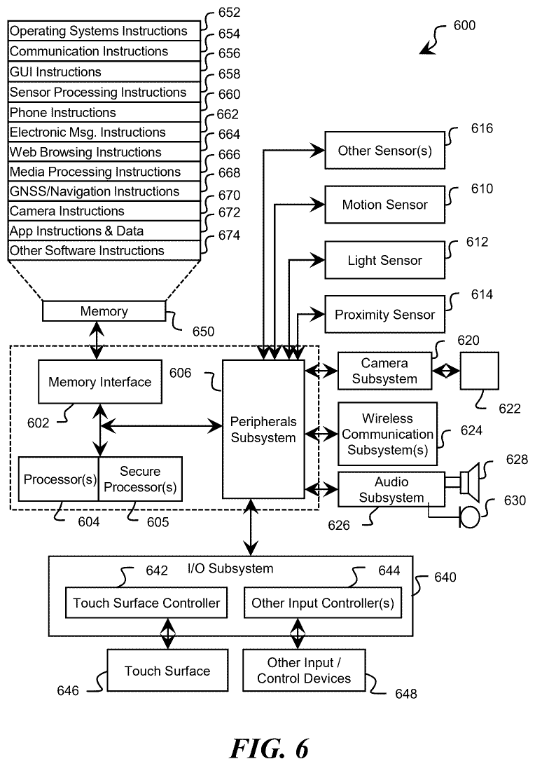

The computing device 102 can include one or more computing devices capable of receiving user input, transmitting and/or receiving data via a network, and or communicating with a server. In some embodiments, the computing device 102 can be a conventional computer system, such as a desktop or laptop computer. Alternatively, the computing device 102 can be a device having computer functionality, such as a personal digital assistant (PDA), a mobile telephone, a smartphone, or other suitable device. In some embodiments, the computing device 102 can be the same as or similar to the computing device 600 described below with respect to FIG. 6.

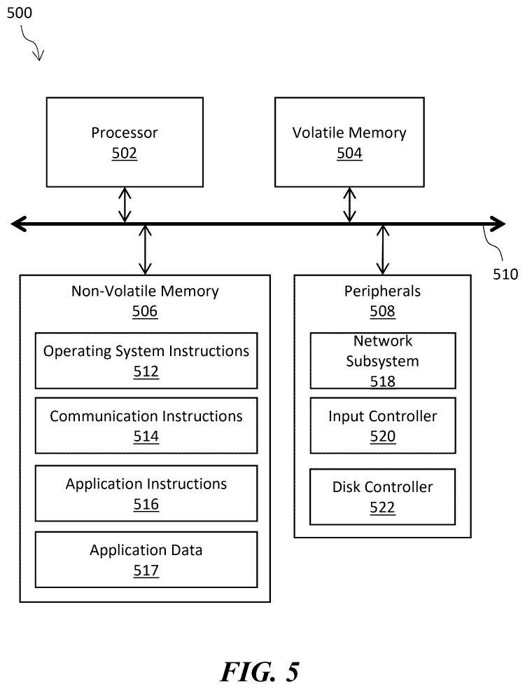

In some embodiments, the computing device 102 could also be a server. For example, the server may include any combination of one or more of web servers, mainframe computers, general-purpose computers, personal computers, or other types of computing devices. The server may represent distributed servers that are remotely located and communicate over a communications network, or over a dedicated network such as a local area network (LAN). The server may also include one or more back-end servers for carrying out one or more aspects of the present disclosure. In some embodiments, the server may be the same as or similar to server 500 described below in the context of FIG. 5.

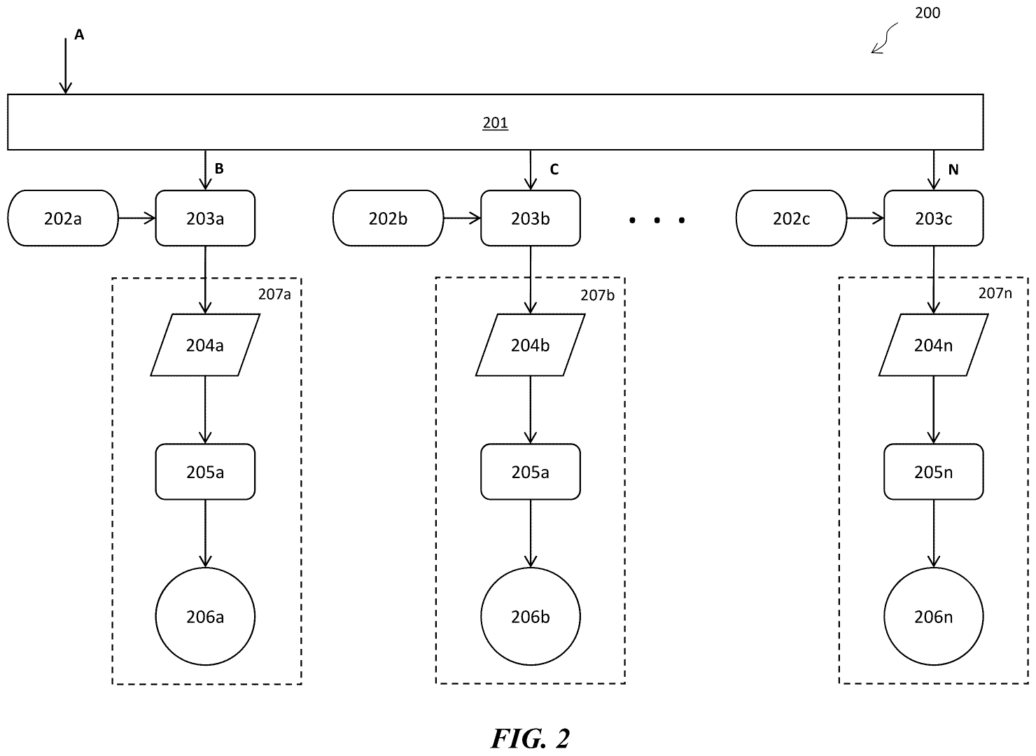

FIG. 2 is an example flow pattern 200 for process and file behavioral execution prevention according to some embodiments of the present disclosure. The flow pattern 200 can utilize an entry hook timeline 201 and operates within the kernel of a computing device, such as the kernel 110 of FIG. 1. At “A”, a kernel function is called, invoking execution of a function or process within the kernel 110. From the entry hook timeline 201 at “B”, a program 202a executes. In some embodiments, the program 202a can execute in a sandbox within the kernel 110, such as via eBpf. In response to an event or condition being detected via the program 202a, a hook mechanism 203a is invoked, which can trigger a callback function 207a. In some embodiments, the callback function 207a can include custom logic 204a (e.g., predefined or preconfigured by a developer or other user). The custom logic 204a can entail other processes and procedures to be performed within the kernel 110. Moreover, after execution of the custom logic 204a, a tailing mechanism 205a can be invoked to execute a complex rules engine or other logic. A shared map 206a can then be updated and written to with conclusions from the previously executed logic. In addition, the entry hook timeline 201 can include various additional processes and callback functions 207b-207n.

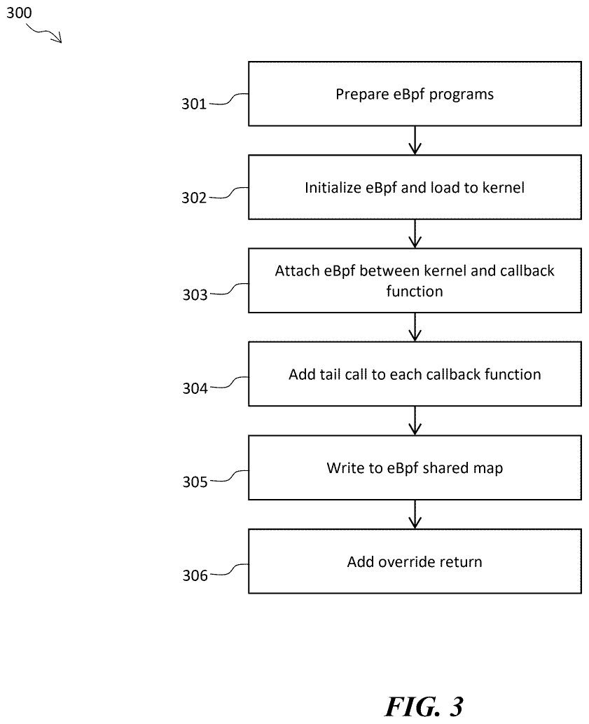

FIG. 3 shows an example process 300 for configuring a method for process and file behavioral execution prevention according to some embodiments of the present disclosure. At block 301, one or more eBpf (or otherwise sandboxed) programs are prepared. In some embodiments, each program can have a different hook callback function. In addition, the various programs can be built with the same prototype of the kernel function that the respective program will be hooked to. In some embodiments, blocks 302-305 can be performed for each of the programs prepared at block 301. At block 302, each program is initialized and loaded to the kernel 110. At block 303, each program is attached between the kernel 110 and the callback function. In some embodiments, the order of attaching the various programs determines the order in which they are invoked during operation. For example, the last program to be attached will be called first (LIFO). At block 304, a tail call or tailing mechanism is added to each callback function to execute a complex rules engine or other logic. At block 305, the conclusions from the various executed logics are written to a shared map (e.g., an eBpf shared map), which can enable accommodating a mutual behavior between the various programs. At block 306, an override return is added to the last program according to the decisions made by the previous programs.

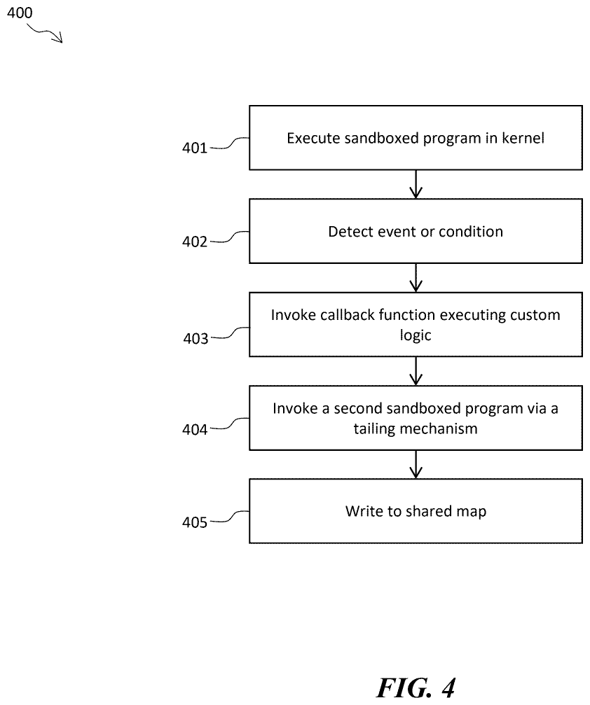

FIG. 4 shows an example process 400 for process and file behavioral execution prevention according to some embodiments of the present disclosure. Process 400 can be executed within the kernel 110 of the computing device 102, providing the various benefits described herein. For example, process 400 could be performed to detect and prevent malicious activity within the computing device 102, such as by preventing file access or process execution. However, process 400 could also be performed in various other applications, wherever it is desirable to extend the complexity of logic executing within the kernel 110.

At block 401, a sandboxed program (e.g., via eBpf) executes in the kernel 110. At block 402, the sandboxed program detects an event or condition. which can be predefined and/or preconfigured. For example, the program could detect an attempt at opening a file or initiating a process, among many others including any Linux system call (mmap, sockets, etc.). At block 403, in response to detecting the event or condition, a callback function executing custom logic is invoked. For example, the custom logic may operate to counteract or otherwise deal with the detected event or condition. At block 404, a second sandboxed program is invoked via a tailing mechanism and also executes within the kernel 110. At block 405, the results and/or conclusions of the logic and the programs is written to a shared map. It is important to note that, while process 400 includes two sandboxed programs executing within the kernel, the disclosed embodiments are not limited to this number, and additional numbers of programs may be used, depending on the level of complexity desired for the particular application.

FIG. 5 is a diagram of an example server device 500 that can be used within the disclosed systems. Server device 500 can implement various features and processes as described herein. Server device 500 can be implemented on any electronic device that runs software applications derived from complied instructions, including without limitation personal computers, servers, smart phones, media players, electronic tablets, game consoles, email devices, etc. In some implementations, server device 500 can include one or more processors 502, volatile memory 504, non-volatile memory 508, and one or more peripherals 508. These components can be interconnected by one or more computer buses 510.

Processor(s) 502 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 510 can be any known internal or external bus technology, including but not limited to ISA, EISA, PCI, PCI Express, USB, Serial ATA, or FireWire. Volatile memory 504 can include, for example, SDRAM. Processor 502 can receive instructions and data from a read-only memory or a random access memory or both. Essential elements of a computer can include a processor for executing instructions and one or more memories for storing instructions and data.

N on-volatile memory 506 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 506 can store various computer instructions including operating system instructions 512, communication instructions 514, application instructions 516, and application data 517. Operating system instructions 512 can include instructions for implementing an operating system (e.g., MacOS®, Windows®, or Linux). The operating system can be multi-user, multiprocessing, multitasking, multithreading, real-time, and the like. Communication instructions 514 can include network communications instructions, for example, software for implementing communication protocols, such as TCP/IP, HTTP, Ethernet, telephony, etc. Application instructions 516 can include instructions for various applications. Application data 517 can include data corresponding to the applications.

Peripherals 508 can be included within server device 500 or operatively coupled to communicate with server device 500. Peripherals 508 can include, for example, network subsystem 518, input controller 520, and disk controller 522. Network subsystem 518 can include, for example, an Ethernet of WiFi adapter. Input controller 520 can be any known input device technology, including but not limited to a keyboard (including a virtual keyboard), mouse, track ball, and touch-sensitive pad or display. Disk controller 522 can include one or more mass storage devices for storing data files; such devices include magnetic disks, such as internal hard disks and removable disks; magneto-optical disks; and optical disks.

FIG. 6 is an example computing device that can be used within the disclosed systems, according to an embodiment of the present disclosure. The illustrative user device 600 can include a memory interface 602, one or more data processors, image processors, central processing units 604, and/or secure processing units 605, and peripherals subsystem 606. Memory interface 602, one or more central processing units 604 and/or secure processing units 605, and/or peripherals subsystem 606 can be separate components or can be integrated in one or more integrated circuits. The various components in user device 600 can be coupled by one or more communication buses or signal lines.

Sensors, devices, and subsystems can be coupled to peripherals subsystem 606 to facilitate multiple functionalities. For example, motion sensor 610, light sensor 612, and proximity sensor 614 can be coupled to peripherals subsystem 606 to facilitate orientation, lighting, and proximity functions. Other sensors 616 can also be connected to peripherals subsystem 606, such as a global navigation satellite system (GNSS) (e.g., GPS receiver), a temperature sensor, a biometric sensor, magnetometer, or other sensing device, to facilitate related functionalities.

Camera subsystem 620 and optical sensor 622, e.g., a charged coupled device (CCD) or a complementary metal-oxide semiconductor (CMOS) optical sensor, can be utilized to facilitate camera functions, such as recording photographs and video clips. Camera subsystem 620 and optical sensor 622 can be used to collect images of a user to be used during authentication of a user, e.g., by performing facial recognition analysis.

Communication functions can be facilitated through one or more wired and/or wireless communication subsystems 624, which can include radio frequency receivers and transmitters and/or optical (e.g., infrared) receivers and transmitters. For example, the Bluetooth (e.g., Bluetooth low energy (BTLE)) and/or WiFi communications described herein can be handled by wireless communication subsystems 624. The specific design and implementation of communication subsystems 624 can depend on the communication network(s) over which the user device 600 is intended to operate. For example, user device 600 can include communication subsystems 624 designed to operate over a GSM network, a GPRS network, an EDGE network, a WiFi or WiMax network, and a Bluetooth™ network. For example, wireless communication subsystems 624 can include hosting protocols such that device 600 can be configured as a base station for other wireless devices and/or to provide a WiFi service.

Audio subsystem 626 can be coupled to speaker 628 and microphone 630 to facilitate voice-enabled functions, such as speaker recognition, voice replication, digital recording, and telephony functions. Audio subsystem 626 can be configured to facilitate processing voice commands, voice-printing, and voice authentication, for example.

I/O subsystem 640 can include a touch-surface controller 642 and/or other input controller(s) 644. Touch-surface controller 642 can be coupled to a touch-surface 646. Touch-surface 646 and touch-surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 646.

The other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of speaker 628 and/or microphone 630.

In some implementations, a pressing of the button for a first duration can disengage a lock of touch-surface 646; and a pressing of the button for a second duration that is longer than the first duration can turn power to user device 600 on or off. Pressing the button for a third duration can activate a voice control, or voice command, module that enables the user to speak commands into microphone 630 to cause the device to execute the spoken command. The user can customize a functionality of one or more of the buttons. Touch-surface 646 can, for example, also be used to implement virtual or soft buttons and/or a keyboard.

In some implementations, user device 600 can present recorded audio and/or video files, such as MP3, AAC, and MPEG files. In some implementations, user device 600 can include the functionality of an MP3 player, such as an iPod™. User device 600 can, therefore, include a 36-pin connector and/or 8-pin connector that is compatible with the iPod. Other input/output and control devices can also be used.

Memory interface 602 can be coupled to memory 650. Memory 650 can include high-speed random access memory and/or non-volatile memory, such as one or more magnetic disk storage devices, one or more optical storage devices, and/or flash memory (e.g., NAND, NOR). Memory 650 can store an operating system 652, such as Darwin, RTXC, LINUX, UNIX, OS X, Windows, or an embedded operating system such as VxWorks.

Operating system 652 can include instructions for handling basic system services and for performing hardware dependent tasks. In some implementations, operating system 652 can be a kernel (e.g., UNIX kernel). In some implementations, operating system 652 can include instructions for performing voice authentication.

Memory 650 can also store communication instructions 654 to facilitate communicating with one or more additional devices, one or more computers and/or one or more servers. Memory 650 can include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic messaging-related process and functions; web browsing instructions 664 to facilitate web browsing-related processes and functions; media processing instructions 666 to facilitate media processing-related functions and processes; GNSS/N avigation instructions 668 to facilitate GNSS and navigation-related processes and instructions; and/or camera instructions 670 to facilitate camera-related processes and functions.

Memory 650 can store application (or “app”) instructions and data 672, such as instructions for the apps described above in the context of FIGS. 2-4. Memory 650 can also store other software instructions 674 for various other software applications in place on device 600.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

1. A method for process and file behavioral execution prevention comprising:
executing a first sandboxed program within a kernel of a computing device;
detecting, via the sandboxed program, an event or a condition;
in response to detecting the event or condition, invoking a callback function executing custom logic;
invoking, via a tailing mechanism, a second sandboxed program to execute within the kernel; and
writing outputs of the first and second sandboxed programs to a shared map.

2. The method of claim 1, wherein the first and second sandboxed programs are extended Berkeley Packet Filter (eBpf) programs.

3. The method of claim 1, wherein the shared map comprises an eBpf shared map.

4. The method of claim 1, wherein the first and second sandboxed programs are attached between the kernel and respective callback functions.

5. The method of claim 1 comprising, in response to the second sandboxed program completing execution, performing an override return.

6. The method of claim 1, wherein the event or the condition comprises at least one of opening a file or initiating a process.

7. The method of claim 1, where executing the custom logic comprises at least one of inspecting or modifying a data structure or invoking an additional kernel function.

8. The method of claim 1, wherein the custom logic is executed to prevent malicious activity.

9. A computing system comprising:
a processor; and
a non-transitory computer-readable storage device storing computer-executable instructions, the instructions when executed by the processor cause the processor to perform operations comprising:
executing a first sandboxed program within a kernel of a computing device;
detecting, via the sandboxed program, an event or a condition;
in response to detecting the event or condition, invoking a callback function executing custom logic;
invoking, via a tailing mechanism, a second sandboxed program to execute within the kernel; and
writing outputs of the first and second sandboxed programs to a shared map.

10. The computing system of claim 9, wherein the first and second sandboxed programs are extended Berkeley Packet Filter (eBpf) programs.

11. The computing system of claim 9, wherein the shared map comprises an eBpf shared map.

12. The computing system of claim 9, wherein the first and second sandboxed programs are attached between the kernel and respective callback functions.

13. The computing system of claim 9, wherein the operations comprise, in response to the second sandboxed program completing execution, performing an override return.

14. The computing system of claim 9, wherein the event or the condition comprises at least one of opening a file or initiating a process.

15. The computing system of claim 9, where executing the custom logic comprises at least one of inspecting or modifying a data structure or invoking an additional kernel function.

16. The computing system of claim 9, wherein the custom logic is executed to prevent malicious activity.
